(19) United States
(12) Patent Application Publication
(10) Pub. No.: US 2007/0178906 A1
(43) Pub. Date: Aug. 2, 2007

(54) Sharing load method in wireless cellular overlap area

(75) Inventors: Quanzhong Gao, Shenzhen (CN); Shoubo Xie, Shenzhen (CN); Ying Tan, Shenzhen (CN); Yilin Wu, Shenzhen (CN); Bin Gan, Shenzhen (CN); Yongjian Mou, Shenzhen (CN)

Correspondence Address: WOLF GREENFIELD & SACKS, P.C., 600 ATLANTIC AVENUE, BOSTON, MA, 02210-2206, US

(73) Assignee: Huawei Technologies Co., Ltd., Shenzhen (CN)

(21) Appl. No.: 11/707,656

(22) Filed: Feb. 16, 2007

Related U.S. Application Data
(63) Continuation-in-part of application No. PCT/CN05/01272, filed on Aug. 16, 2005.

(30) Foreign Application Priority Data
Aug. 18, 2004 (CN) 200410058547.3

(51) Int. Cl. H04Q 7/20

(52) U.S. Cl. 455/453

(57) ABSTRACT

An embodiment of the present invention provides a method for implementing load sharing in an overlap area of wireless cellular networks wherein the overlap area of the wireless cellular networks includes at least two networks. The method includes: obtaining load indication information of a network within the overlap area: transmitting the load indication information to a mobile terminal; and selecting a network for residing in or a network to be accessed when initiating a service connection according to the load indication information. Another embodiment of the present invention provides a system for implementing load sharing in an overlap area of wireless cellular networks. According to the embodiments of the present invention, the load between networks in an overlap area may be balanced. Network congestion may be reduced and network resources may be utilized effectively.

### CROSS REFERENCE TO RELATED APPLICATIONS

This application is a continuation-in-part of PCT application number PCT/CN2005/001272, filed Aug. 16, 2005 entitled METHOD AND SYSTEM FOR IMPLEMENTING LOAD SHARING IN OVERLAP AREA OF WIRELESS CELLULAR NETWORKS, which application is incorporated herein by reference in its entirety.

### FIELD OF THE INVENTION

The present invention relates to wireless communication technology, and particularly to a method and a system for implementing load sharing in an overlap area of wireless cellular networks.

### BACKGROUND OF THE INVENTION

The CDMA2000-1× (the first stage) technology supports voice service and data service through a standard (1×) CDMA channel, many performances of which are more predominant than those of other technologies. The capacity of the CDMA2000-1× is approximately twice as large as that of the previous CDMA (Code Division Multiple Access) system, so the demands of continuously developing voice service and new services of the wireless Internet may be satisfied. The highest speed of the CDMA2000-1× may reach 153 kbps, which will reach 307 kbps or even 3.1 Mbps in the future. Thus, the voice performance may not be lowered for the sake of the data performance.

With the increasing popularity of mobile communication, only mobile voice communication is unable to meet the demand of people for obtaining information. Mobile data communication service presents strong vitality and prospect because it provides business, entertainment and cross-region communication with others. For users expecting to obtain higher-rate or larger-capacity data processing services, the data optimized version 1× EX-DO (Evolution Data Optimized) of the CDMA 2000 is a kind of optimized technology for implementing high-rate wireless packet data service, which is named as HRPD (High Rate Packet Data) by the 3GPP2 (3^{rd} Generation Partnership Project 2) standardization organization. The highest rate may exceed 2 Mbps. The throughput may exceed 700 kbps. The 1× EV-DO is comparable to the cable Digital Subscriber Line (DSL) and supports the applications with stricter demand on rate, such as video transmission, large-sized file download and so on. The cost for transmitting 1M bytes of the CDMA2000 1× EV-DO is the lowest, which is a very important factor to promote the popularity of the wireless Internet. The 1× EV-DO is backward-compatible with the CDMA2000 1×. The radio frequency characteristics and the network planning of the 1× EV-DO are the same as those of the CDMA2000 1×. The smooth upgrade for operators may be guaranteed.

In a wireless cellular system, with the increase of CDMA users and demands of the users, a CDMA2000 1× system is restricted by bandwidth and rate during developing high-rate data services. An HRPD system will be introduced to support the high-rate data services. The network structure of the HRPD system is shown in FIG. 1.

Similar to the BTS and BSC of the CDMA2000, the HRPD BTS (Base Transceiver Station) and the HRPD BSC (Base Station Controller) are the Access Network (AN) part. The AN AAA is an Access Network AAA (Authentication, Authorization and Accounting) server which is used to authenticate for users accessing the HRPD wireless network.

### SUMMARY OF THE INVENTION

A method for implementing load sharing in an overlap area of wireless cellular networks, wherein the overlap area of the wireless cellular networks includes at least two networks. The method includes: obtaining load indication information of a network within the overlap area; transmitting the load indication information to a mobile terminal; and selecting a network for residing in or a network to be accessed when initiating a service connection according to the load indication information.

Preferably, the transmitting the load indication information to a mobile terminal further includes: transmitting the load indication information to the mobile terminal through a control channel, including:

carrying the load indication information in a system message transmitted through the control channel; and,

transmitting the system message carrying the load indication information to the mobile terminal through the control channel.

Preferably, the carrying the load indication information in a system message transmitted through the control channel includes:

extending the system message transmitted through the control channel, and adding a load indication information field; and,

adding the load indication information into the load indication information field.

Preferably, the control channel is a common control channel or a broadcast channel.

Preferably, the transmitting the load indication information to a mobile terminal further includes:

establishing a load indication channel; and, transmitting the load indication information to the mobile terminal through the load indication channel.

Preferably, the load indication channel is a load indication channel established on a physical channel or a load indication channel established on a logical channel;

Preferably, the transmitting the load indication information to the mobile terminal through the load indication channel further includes:

if the load indication channel is established on the physical channel, modulating the load indication information on a physical carrier;

if the load indication channel is established on the logical channel, adding the load indication information into a packet processed by a physical layer.

Preferably, the selecting a network for residing in or a network to be accessed when initiating a service connection according to the load indication information includes:

setting load threshold values of the networks respectively; and,

when the load indication information received by the mobile terminal is larger than a load threshold value of the network which the mobile terminal is in, switching the mobile terminal to another network within the overlap area.

Preferably, the load threshold values of the networks may be set through a Subscriber Identity Module (SIM) card of the mobile terminal, or by means of short message, or by means of protocol convention.

An embodiment of the present invention provides a method for implementing load sharing in an overlap area of sectors/cells in a wireless cellular network, wherein the overlap area includes at least two sectors/cells in the wireless cellular network. The method includes: obtaining load indication information of a sector/cell within the overlap area; transmitting the obtained load indication information to a mobile terminal; selecting a sector/cell for residing in or a sector/cell to be accessed when initiating a service connection according to the received load indication information.

An embodiment of the present invention provides a method for implementing load sharing in an overlap area of frequency bands in a wireless cellular network, wherein the overlap area includes at least two frequency bands in the wireless cellular network. The method includes: obtaining load indication information of a frequency band within the overlap area; transmitting the obtained load indication information to a mobile terminal; selecting a frequency band for residing in or a frequency band to be accessed when initiating a service connection according to the received load indication information.

An embodiment of the present invention provides a system for implementing load sharing in an overlap area of wireless cellular networks, wherein the overlap area of the wireless cellular networks includes at least two networks. The system includes: a network side, obtaining load indication information of a network within the overlap area and transmitting the load indication information to a mobile terminal; a mobile terminal, receiving the load indication information and selecting a network for residing in or a network to be accessed when initiating a service connection according to the load indication information.

An embodiment of the present invention provides a system for implementing load sharing in an overlap area in a wireless cellular network, wherein the overlap area includes at least two sectors/cells in the wireless cellular network. The system includes: a network side, obtaining load indication information of a sector/cell within the overlap area and transmitting the load indication information to a mobile terminal; a mobile terminal, receiving the load indication information and selecting a sector/cell for residing in or a sector/cell to be accessed when initiating a service connection according to the load indication information.

An embodiment of the present invention provides a system for implementing load sharing in an overlap area in a wireless cellular network, wherein the overlap area includes at least two frequency bands in the wireless cellular network. The system includes: a network side, obtaining load indication information of a frequency band within the overlap area and transmitting the load indication information to a mobile terminal; a mobile terminal, receiving the load indication information and selecting a frequency band for residing in or a frequency band to be accessed when initiating a service connection according to the load indication information.

According to some embodiments of the present invention, the load between the networks in an overlap area may be balanced. Network congestion may be reduced and network resources may be utilized effectively.

### BRIEF DESCRIPTION OF THE DRAWINGS

FIG.1 is a simplified diagram illustrating a network structure in which the CDMA2000 1× overlaps with the HRPD;

FIG.2 is a simplified schematic diagram illustrating adjustment for a reverse service channel rate in a CDMA2000 1× system;

FIG.3 is a simplified flow chart of an embodiment of the present invention.

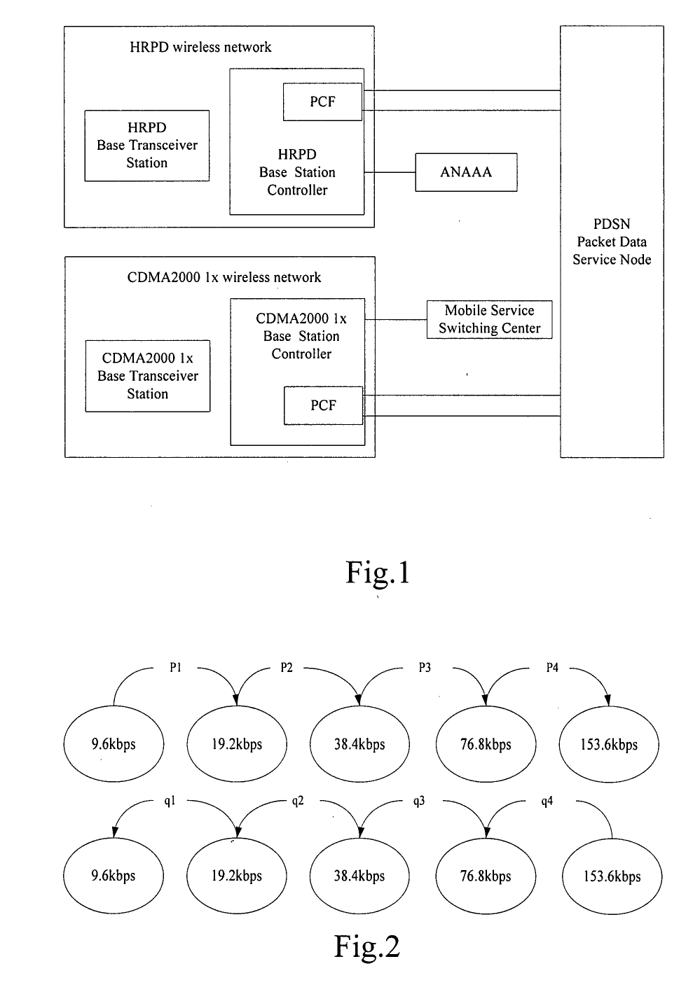

### DETAILED DESCRIPTION

For example, in order to support voice service and data service simultaneously, an HRPD system may overlap with a CDMA2000 system. In an overlap area of the HRPD system and the CDMA2000 system, a CDMA2000/HRPD dual-mode mobile phone may select either of the two networks as its own service network or change its own service network as required. The mobile phone may select to reside in the CDMA2000 system or reside in the HRPD system after it is powered on. Operators may set which network the terminal may reside in as required. But at present, there is no strategy for balancing between the two networks. It is possible that more mobile phones reside in the CDMA2000 network in a certain period. Thus too many users select the CDMA2000 network of the overlap area to implement data service calls. Accordingly the load of the CDMA2000 network of the overlap area is too heavy while the load of the HRPD network of the same overlap area is too light. It is also possible that the load of the HRPD network is too heavy while the load of the CDMA2000 network is too light.

Similarly, for a WCDMA (Wideband Code Division Multiple Access) system, a TD-SCDMA (Time Division-Synchronous Code Division Multiple Access) system and a GSM (Global System for Mobile Communication) system, in an overlap area of different networks, a mobile phone supporting these systems may face an issue of selecting a network for residing in and a network to be accessed when initiating a service connection.

Different wireless cellular systems may transmit a relevant system message and paging through a control channel periodically. A terminal processes correspondingly according to the received system message and paging.

In general, the system message may include system parameters (such as, system time etc.), a neighbor list (such as, a surrounding sector list convenient for a mobile phone to receive information of neighbor sectors), access parameters (relevant parameters of an access channel, system load, etc.) and so on. Though the system messages of many wireless cellular system networks include message contents such as the access parameters, there is no parameter indicating the load of a sector in the system messages. Before implementing a service connection, a terminal is unable to determine whether the system is idle and employ a reasonable strategy to access a corresponding network. Similarly, the terminal will not be switched to another network with relatively light load in an idle state to lighten the load of a network with relatively heavy load.

According to embodiments of the present invention, load of a system is indicated through extending a system message of a wireless cellular system or adding a load indication channel. A mobile terminal selects a network for residing in or a network to be accessed when initiating a service connection according to a load indication. Thus load of different networks within an overlap area of wireless cellular networks may be balanced.

Those skilled in the art should know that in a wireless cellular network, a mobile phone captures a system, and obtains system time, synchronization information and channel parameters of the system etc. after it is powered on. After the above operation, the mobile phone starts to obtain relevant parameters of the system including system parameters, system time, a neighbor list and access parameters, etc. from a control channel (a common control channel or a broadcast channel), logs in and registers. Then the mobile phone stays in an idle state, monitors a system message and paging transmitted by the control channel periodically. If the mobile phone receives the paging or needs to initiate a call, the mobile phone enters a connection state. After the call is finished, the mobile phone subsequently returns to the idle state to monitor the system message and paging. Hereinafter the method will be described with an example of an overlap area of a CDMA 2000 1× network and a HRPD network.

In a CDMA 2000 1× network and a HRPD network, a system may transmit a relevant system message and paging through a control channel periodically. A terminal may perform corresponding processing according to the received system message and paging.

In a CDMA2000 1× system, a system message transmitted through a common control channel periodically generally includes:

ANSI-41 System Parameters Message

User Zone Identification Message

Private Neighbor List Message

Extended Global Service Redirection Message

Extended CDMA Channel List Message

MC-RR Parameters Message

Universal Neighbor List Message

Enhanced Access Parameters Message

In a CDMA2000 1× system, a system message transmitted through a broadcast channel periodically generally includes:

System Parameters Message

Neighbor List Message (Band Class 0 only)

Access Parameter Message

CDMA Channel List Message

Extended System Parameter message 4

Extended Neighbor List Message (Band Class 1 only)

General Neighbor List Message

Global Service Redirection Message

User Zone Identification Message

Private Neighbor List Message

Extended Global Service Redirection Message

Extended CDMA Channel List Message

In an HRPD network, both a system message and paging are transmitted through a synchronous control channel periodically. The transmitted system message generally includes: QuickConfig (Quick Configuration) message and SectorParameters (Sector Parameters) message. Wherein, the QuickConfig message is used for indicating how a terminal accesses a network, but this message does not include load information. The SectorParameters message includes a relatively fixed system message such as information of a sector and neighbor information. It includes:

MessageID: message identifier, identifying a message type;

CountryCode: country code, identifying a country that a sector belongs to;

SectorID: sector ID, identifying a sector code;

SubnetMask: subnet mask, expressing information of a subnet that a sector belongs to;

SectorSignature: sector signature, expressing whether parameters of a sector are changed;

Latitude: latitude, expressing geographic location information of a sector;

Longitude: longitude, expresses geographic location information of a sector, etc.

In addition, an HRPD system also has a special RA (Reverse Activity) channel used for indicating whether current load of the system is too heavy. The RA channel is used for indicating a terminal in a service connection state to increase or decrease a reverse rate to a proper value, so that the system may keep a reverse maximum throughput, while overload may be avoided.

The operational principle of the RA channel is as follows:

A terminal automatically adjusts a rate based on a RAB (Reverse Activity Bit) forward broadcast by an activity centralized sector, as shown in FIG. 2:

RAB=1, the rate is decreased with probability q. RAB=0, the rate is increased with probability p. If the rate is lower than 9.6 k, it will not be decreased. If the rate is higher than the maximum limit rate (which is set by each terminal individually, wherein the reverse maximum rate is 153.6 k), it will not be increased.

In general, under the same channel conditions, the higher the rate, the higher the demand on power. If the power is not enough (the terminal compares its emission power with a power control value of the system for the terminal, if the maximum emission power is lower than the power control value, the power is not enough), the rate will not be increased by increasing the power.

According to an embodiment of the present invention, load indication information is added into a system message by extending the system message. The information is transmitted to a mobile terminal periodically. The mobile terminal selects a proper network for residing in or a network to be accessed when a service connection is established according to the load indication information. Of course, a special load indication channel also may be established. The load indication information is transmitted to the mobile terminal through the channel periodically. The mobile terminal adjusts its strategy for residing and its strategy for selecting a network when initiating a service connection according to the load indication information of the system side.

Hereinafter the present invention will be further detailed with reference to the accompanying drawings and the embodiments so that those skilled in the art may understand the scheme of the present invention clearly.

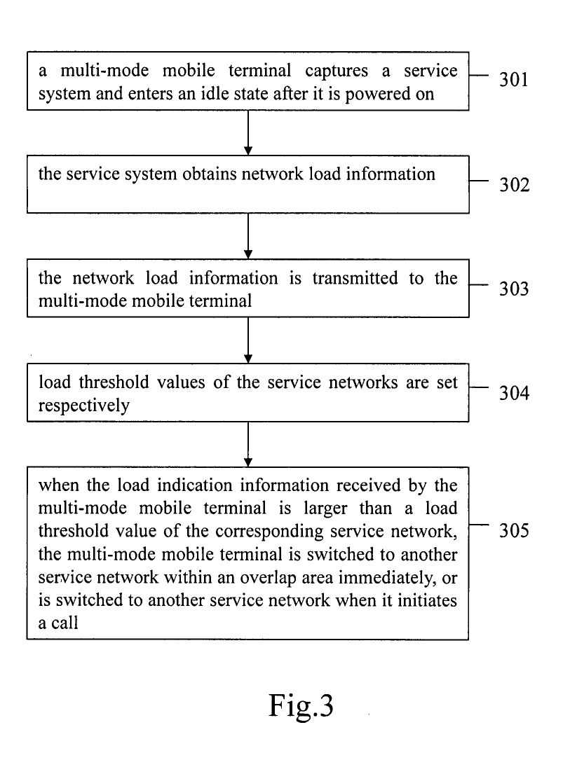

FIG. 3 is a flow chart according to an embodiment of the present invention, including:

Step 301: a mobile terminal captures a service system and enters an idle state after it is powered on.

In a wireless cellular network, the mobile phone captures the system, obtains system time, synchronization information and channel parameters of the system after it is powered on. After the above operation, the mobile phone starts to obtain relevant parameters of the system through a control channel (a common control channel or a broadcast channel), such as system parameters, system time, a neighbor list and access parameters, etc., then logs in and registers. After logging in and registering, the mobile phone stays in an idle state and monitors a system message and paging transmitted by the control channel periodically. If the mobile phone receives a paging or it needs to initiate a call, the mobile phone enters a connection state. After the call is finished, the mobile phone subsequently returns to the idle state to monitor the system message and paging.

Step 302: the service system obtains load indication information of the network.

For example, a CDMA system obtains load indication information of a network by querying its actual system load (indicating system load is a main function of a resource management module of each service system) and comparing the actual system load with a capacity threshold.

Step 303: the load indication information is transmitted to the mobile terminal.

The process may be implemented through the following approaches.

The load indication information is transmitted to the mobile terminal through the control channel.

Those skilled in the art should know that, with respect to a CDMA system, an HRPD system, a GSM system or a TD-SCDMA system, each system may transmit a system message to a mobile terminal in a network through a control channel periodically. The system message includes: system parameters, a neighbor list and access parameters, etc. Some of these system messages are transmitted through a common control channel, and some of them are transmitted through a broadcast channel. Thus the obtained load indication information may be transmitted to the mobile terminal through a common control channel or a broadcast channel.

Hereinafter the detailed processes are described respectively.

The load indication information is transmitted to the mobile terminal through the broadcast channel.

the system message transmitted through the broadcast channel are extended, and a load indication information field is added;

the obtained load indication information is added into the load indication information field;

the system message carrying the load indication information are transmitted to the mobile terminal through the broadcast channel periodically.

Of course, the system message may be set as “must be transmitted” and “optionally be transmitted” according to the demand of the system. For example, whether a following message includes system load indication information may be indicated in a system parameters message.

In addition, the length of the load indication information may be configured as required. For example, system load is classified into a number of levels to be indicated exactly. Such as, 4 bits may be used to identify 16 levels at most, and 8 bits may be used to identify 256 levels at most.

b. The load indication information is transmitted to the mobile terminal through the common control channel.

the system message transmitted through the common control channel are extended, and a load indication information field is added;

the obtained load indication information is added into the load indication information field;

the system message carrying the load indication information are transmitted to the mobile terminal through the common control channel periodically.

Besides transmitting the obtained load indication information to the mobile terminal through an existing control channel, the following approach may be used.

2. The load indication information is transmitted to the mobile terminal by adding a load indication channel.

a load indication channel is established. The load indication channel may be established on a physical channel or on a logical channel.

If the load indication channel is established on a physical channel, similar to the approach of the RA channel described above, the load indication information is directly modulated on a physical carrier in the channel. If the load indication channel is established on a logical channel, the load indication information is contained in a Media Access Control(MAC) packet processed by a physical layer.

(2) the load indication information is transmitted to the mobile terminal through the load indication channel periodically.

Step 304: load threshold values of the networks are respectively set.

For example, the load threshold values of the networks may be set through a Subscriber Identity Module(SIM) card of a mobile terminal in advance.

The load threshold values of the networks also may be set by means of short message. After the mobile terminal logs in and registers, the system transmits a short message containing the load indication information of the system to the mobile terminal periodically. Thus, the mobile terminal may know the load of the network it resides in time.

The load threshold values of the networks also may be set by means of protocol convention. Different operators provide their respective protocols. The mobile terminal obtains the load threshold value of the network according to the protocol.

Step 305: when the load indication information received by the mobile terminal is larger than a load threshold value of a service network which the mobile terminal is in, the mobile terminal is switched to another service network within the overlap area, or is switched to another service network when it initiates a call.

The load indication information received by the mobile terminal may be the information of the network which the mobile terminal is in or the information of the networks in the overlap area.

The load threshold value of a network may be determined by an operator or may be regulated by a protocol. For example, the load threshold value may be set to 80% or 70% of the maximum system load, etc. A terminal determines whether the load of the network exceeds the load threshold value according to the load indication information in the received system message and selects whether to change a network for residing in. The terminal also may select which network to reside in after comparing the load indication information of the overlapping networks to keep the load between the networks within the overlap area relatively balanced.

It could be seen from the above embodiment of the present invention that the load of a network is indicated through extending a system message of a wireless cellular system or adding a load indication channel. According to the load indication information, the strategy for residing and the strategy for selecting a network when initiating a service connection may be adjusted and whether the system is idle may be determined, so that a terminal may reasonably select a network to be accessed when initiating a service connection, leave a network with relatively heavy load in advance and lighten the load of the network. Thus load sharing and balancing between networks within an overlap area may be achieved. Network congestion may be reduced and network resources may be used effectively.

Similarly, the method is also applicable to load sharing in an overlap area of sectors/cells in a wireless cellular network and load sharing in an overlap area of frequency bands in a wireless cellular network.

In the case of load sharing in an overlap area of sectors/cells in a wireless cellular network, the process is as follows.

A mobile terminal captures a sector/cell after it is powered on. The network side obtains load indication information of the sector/cell. The load indication information is transmitted to the mobile terminal. The mobile terminal selects a sector/cell for residing in or a sector/cell to be accessed when initiating a service connection according to the load indication information.

The load indication information received by the mobile terminal may be the information of the sector/cell which the mobile terminal is in or the information of the sectors/cells in the overlap area.

In the case of load sharing in an overlap area of frequency bands in a wireless cellular network, the process is as follows.

A mobile terminal captures a frequency band after it is powered on. The network side obtains load indication information of a frequency band. The load indication information is transmitted to the mobile terminal. The mobile terminal selects a frequency band for residing in or a frequency band to be accessed when initiating a service connection according to the load indication information.

The load indication information received by the mobile terminal may be the information of the frequency band which the mobile terminal is in or the information of the frequency bands in the overlap area.

Other processes in the above two cases are similar to that of the first embodiment and will not be described in detail herein.

According to the above methods, a system may be provided for implementing load sharing in an overlap area of wireless cellular networks, wherein the overlap area of the wireless cellular networks includes at least two networks. The system includes a network side and a mobile terminal. The network side obtains load indication information of a network within the overlap area and transmits the load indication information to a mobile terminal. The mobile terminal receives the load indication information and selects a network for residing in or a network to be accessed when initiating a service connection according to the load indication information.

A system also may be provided for implementing load sharing in an overlap area in a wireless cellular network, wherein the overlap area includes at least two sectors/cells in the wireless cellular network. The system includes a network side and a mobile terminal. The network side obtains load indication information of a sector/cell within the overlap area and transmits the load indication information to a mobile terminal. The mobile terminal receives the load indication information and selects a sector/cell for residing in or a sector/cell to be accessed when initiating a service connection according to the load indication information.

A system also may be provided for implementing load sharing in an overlap area in a wireless cellular network, wherein the overlap area includes at least two frequency bands in the wireless cellular network. The system includes: a network side, obtaining load indication information of a frequency band within the overlap area and transmitting the load indication information to a mobile terminal; a mobile terminal, receiving the load indication information and selecting a frequency band for residing in or a frequency band to be accessed when initiating a service connection according to the load indication information.

Though the present invention has been illustrated and described with reference to some preferred embodiments, those skilled in the art should recognize that various variations and modifications may be made without departing from the spirit and scope of the present invention as defined by the accompanying claims.

1. A method for implementing load sharing in an overlap area of wireless cellular networks, wherein the overlap area of the wireless cellular networks comprises at least two networks, the method comprising:
obtaining load indication information of a network within the overlap area;
transmitting the load indication information to a mobile terminal; and
selecting a network for residing in or a network to be accessed when initiating a service connection according to the load indication information.

2. The method of claim 1, wherein the transmitting the load indication information to a mobile terminal comprises: transmitting the load indication information to the mobile terminal through a control channel.

3. The method of claim 2, wherein the transmitting the load indication information to the mobile terminal through a control channel comprises:
carrying the load indication information in a system message transmitted through the control channel; and,
transmitting the system message carrying the load indication information to the mobile terminal through the control channel.

4. The method of claim 3, wherein the carrying the load indication information in a system message transmitted through the control channel comprises:
extending the system message transmitted through the control channel, and adding a load indication information field; and,
adding the load indication information to the load indication information field.

5. The method of claim 2, wherein the control channel comprises one of: a common control channel and a broadcast channel.

6. The method of claim 1, wherein the transmitting the load indication information to the mobile terminal comprises:
establishing a load indication channel; and,
transmitting the load indication information to the mobile terminal through the load indication channel.

7. The method of claim 6, wherein the load indication channel comprises one of:
a load indication channel established on a physical channel and a load indication channel established on a logical channel.

8. The method of claim 7, wherein the transmitting the load indication information to the mobile terminal through the load indication channel comprises:
if the load indication channel is established on the physical channel, modulating the load indication information on a physical carrier;
if the load indication channel is established on the logical channel, adding the load indication information into a packet processed by a physical layer.

9. The method of claim 1, wherein the selecting a network for residing in or a network to be accessed when initiating a service connection according to the load indication information comprises:
setting load threshold values of the networks respectively; and,
when the load indication information received by the mobile terminal is larger than a load threshold value of the network which the mobile terminal is in, switching the mobile terminal to another network within the overlap area.

10. The method of claim 9, wherein the setting load threshold values of the networks respectively comprises:
setting the load threshold values of the networks through a Subscriber Identity Module (SIM) card of the mobile terminal.

11. The method of claim 9, wherein the setting load threshold values of the networks respectively comprises:
setting the load threshold values of the networks by means of short message.

12. The method of claim 9, wherein the setting load threshold values of the networks respectively comprises:
setting the load threshold values of the networks by means of protocol convention.

13. The method of claim 1, wherein the load indication information of the network is obtained by querying actual system load of the network and comparing the actual system load with a capacity threshold.

14. A method for implementing load sharing in an overlap area in a wireless cellular network, wherein the overlap area comprises at least two sectors/cells in the wireless cellular network, the method comprising:
obtaining load indication information of a sector/cell within the overlap area;
transmitting the load indication information to a mobile terminal; and,
selecting a sector/cell for residing in or a sector/cell to be accessed when initiating a service connection according to the load indication information.

15. A method for implementing load sharing in an overlap area in a wireless cellular network, wherein the overlap area comprises at least two frequency bands in the wireless cellular network, the method comprising:
obtaining load indication information of a frequency band within the overlap area;
transmitting the load indication information to a mobile terminal; and,
selecting a frequency band for residing in or a frequency band to be accessed when initiating a service connection according to the load indication information.

16. A system for implementing load sharing in an overlap area of wireless cellular networks, wherein the overlap area of the wireless cellular networks comprises at least two networks, the system comprising:
a network side, obtaining load indication information of a network within the overlap area and transmitting the load indication information to a mobile terminal; and,
a mobile terminal, receiving the load indication information and selecting a network for residing in or a network to be accessed when initiating a service connection according to the load indication information.

17. A system for implementing load sharing in an overlap area in a wireless cellular network, wherein the overlap area comprises at least two sectors/cells in the wireless cellular network, the system comprising:
a network side, obtaining load indication information of a sector/cell within the overlap area and transmitting the load indication information to a mobile terminal; and,
a mobile terminal, receiving the load indication information and selecting a sector/cell for residing in or a sector/cell to be accessed when initiating a service connection according to the load indication information.

18. A system for implementing load sharing in an overlap area in a wireless cellular network, wherein the overlap area comprises at least two frequency bands in the wireless cellular network, the system comprising:
a network side, obtaining load indication information of a frequency band within the overlap area and transmitting the load indication information to a mobile terminal; and,
a mobile terminal, receiving the load indication information and selecting a frequency band for residing in or a frequency band to be accessed when initiating a service connection according to the load indication information.
